(19) United States
(12) Patent Application Publication
(10) Pub. No.: US 2007/0291129 A1
(43) Pub. Date: Dec. 20, 2007

(54) Lighting synchronization to reduce light clutter

(76) Inventor: Vladimir Goupenko, Raleigh, NC (US)

Correspondence Address: John L. Sotomayor, Suite 300, 511 Davis Drive, Morisville, NC, 27560, US

(21) Appl. No.: 11/452,345

(22) Filed: Jun. 14, 2006

(51) Int. Cl. H04N 7/18; H04N 5/225

(52) U.S. Cl. 348/216.1; 348/143

(57) ABSTRACT

When capturing video imagery at night a camera must be more sensitive to incoming light sources. When the light source for the image capture is strobe-like, and the surface of the object to be captured is highly reflective, captured imagery is obscured by light clutter. This invention is a method and process for capturing clear video imagery of an object despite significant light reflection from a strobe-like light source. Light clutter is minimized through de-synchronization of the light source and the image data capture rate.

### TECHNICAL FIELD

When capturing video imagery at night the camera must be more sensitive to incoming light sources. When the light source for the image capture is strobe-like, and the surface of the object to be captured is highly reflective, the captured imagery is obscured by light clutter. The invention disclosed herein recites a method and process for capturing clear video imagery of an object despite significant light reflection from a strobe-like light source.

### BACKGROUND

Capturing an integrated data stream that includes video from within a security vehicle while on a routine stop is well-known. However, image capture is complicated by environmental conditions, such as rain or darkness, the object to be captured within the image, such as highly reflective surfaces, and operational conditions for the vehicle, camera focus length and artificial lighting. There are frequently instances where less than ideal conditions have precluded the capture of significant detail information on the video record.

One such set of conditions that may obscure significant details on the video image record is the combination of a strobe-like artificial light source impacting a highly light reflective surface at night. As an example, at night time conditions are not optimum for the capture of license plate image data. The low ambient light, strobe lighting from the wig-wag lighting unit on top of the police car, severe light scattering due to amount of light from the police vehicle headlights, and the highly reflective coating on the surface of said license plate combine to cause sufficient light scattering to obscure the license plate information in the captured images. However, the amount of light from the headlights alone causes sufficient light scattering to overexpose the image data being captured. Minimizing the light from the headlamps is frequently sufficient to provide for properly exposed image data capture.

The instant invention is a process to be used in conjunction with a digital video image recording system to minimize the impact of light scattering off of a reflective surface to allow clear image data to be captured and stored by the digital video recording system.

### SUMMARY OF THE INVENTION

Digital video recording systems are emplaced within security, service, and transit vehicles to assist with security and liability issues within and surrounding such vehicles. The instant invention is a process and method used with a digital video recording system to improve the capture of video image data under adverse environmental and lighting conditions.

In the preferred embodiment, a security vehicle such as a police patrol car is outfitted with a digital video recording system. When used during a routine traffic stop during daylight hours the digital video recording system captures video images of the vehicle that has been stopped, including such detailed data as images of the license plate on the back of the vehicle. The license plate image is important, and using the digital video recording system to capture this video data frees a police officer from having to divert attention from the vehicle to capture this image data manually.

The current invention uses a non-synchronous timing algorithm to modify the frame capture rate of the digital video device and the light level of the headlamps of the security vehicle such that the frame capture rate and the strobe rate of the headlamps are out of synchronization. In this manner, the digital image capture device captures images of the license plate when there is a minimum of light for the surface to scatter, thus providing clear images of both the stopped vehicle and the license plate in the image record. These clear images may then be used for evidentiary purposes by the law enforcement or security entity.

### BRIEF DESCRIPTION OF THE DRAWINGS

FIG. 1: Process Flow

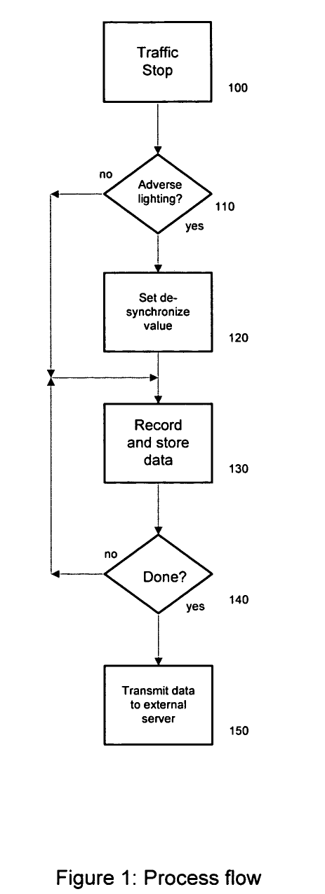

FIG. 2: Frame Capture Operation

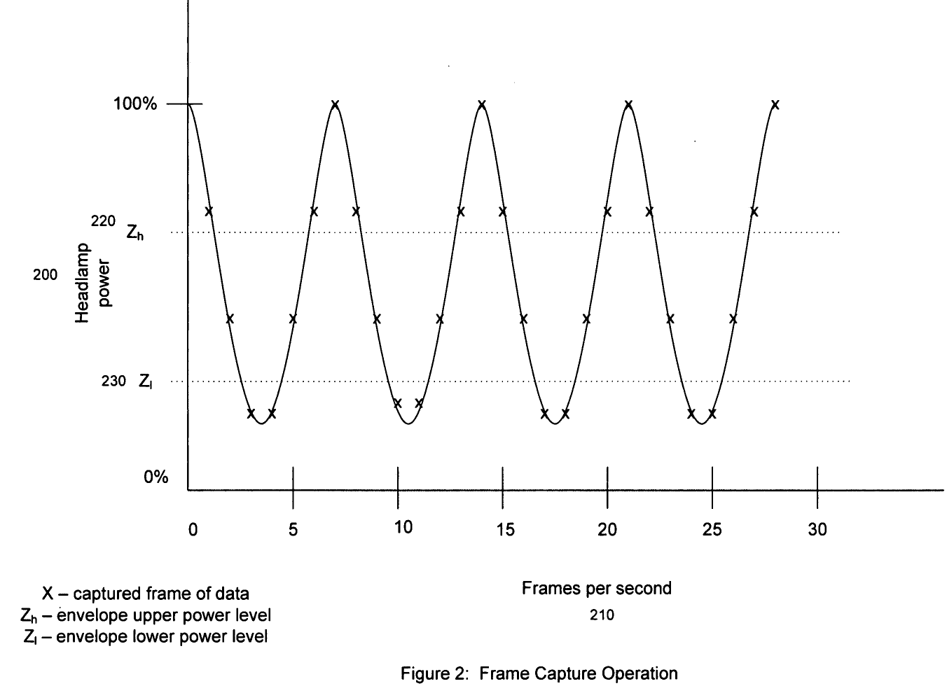

### DETAILED DESCRIPTION OF THE INVENTION

The instant invention is a process and method for minimizing light scattering from a reflective surface such that recorded image data gathered under poor lighting conditions, such as after dark, is sufficient for evidentiary purposes.

In the preferred embodiment, a security vehicle such as a police car has a mobile digital video recording system installed within the vehicle. During a traffic stop 100, the digital video recording system is active to record an integrated stream of video, audio, and meta data of the activity during the traffic stop for later analysis and possible evidentiary use. When the traffic stop 100 occurs during favorable lighting conditions, such as daylight hours in good weather, the ambient lighting conditions provided by sunlight are sufficient to provide proper lighting conditions for data capture of the image of the back of the vehicle that has been stopped by the police officer. Under these conditions, the data is recorded properly without additional manipulation of lighting.

However, when a traffic stop 100 occurs during adverse lighting conditions 110, such as heavy overcast, or at night, additional lighting sources are operative such that highly reflective surfaces are obscured by light scattering. The most powerful sources of illumination from the police vehicle are the headlamps. The illumination and subsequent light scattering from the headlamps during adverse lighting conditions obscures details on the stopped vehicle, the most important of which is the license plate.

Minimizing the light from the headlamps on the police vehicle, and the subsequent light scattering from the highly reflective license plate surface, requires balancing the lighting conditions with the sensitivity of the image data capture. Simply removing the headlamp lighting by turning the headlamps off provides too little light under adverse ambient lighting conditions 110 to clearly record the license plate data. Utilizing programmatic controls to turn the headlamps on and off in synchronization with the speed of integrated data capture, as measured in frames per second of data capture, provides alternating under and over exposed image data. Therefore, to provide the greatest opportunity to capture image data that is neither underexposed nor overexposed, the police vehicle headlamps must be turned on and off, under programmatic control, using a timing algorithm that is non-synchronous 120 with the integrated data capture, as measured in frames per second.

To achieve this non-synchronization 120, the instant invention is a software module installed within the mobile digital video recording system that first discovers the frame rate of the data capture set within the digital video recording system. This value is user programmable and may change in a non-predictable fashion based upon system usage and parameters set within the digital video recording system and could be configured or reset to any value between 1 and n frames per second. In the preferred embodiment, the frame rate 210 is set to thirty frames per second.

Under programmatic control, the power to the headlamps 200 is turned on and off. Flashing the headlamps on and off thirty times per second would be no different than leaving the beams on at full power because every captured data frame would continue to be at full power and thus continue to be overexposed. However, in the present invention, the headlamps are turned on and off in a timing scheme that is not evenly divisible into 30 Hertz, providing a full-lit to dimly-lit cycle at n Hertz. In this fashion, the data frames captured by the digital video recording system range from overexposed, to well exposed, to underexposed, thus providing a subset of captured data frames that are perfectly exposed in terms of lighting and fully show all of the details of the license plate without any light clutter or scattering effects to mar the data. In addition, the n times per second headlamp cycle may be tuned such that the police officer does not perceive the interruption of light as anything more than the briefest of flickers.

The present invention provides for a software module that controls both the frame rate per second 210 for the data capture, and the timing of the power-up to power-down cycle 200 of the headlamps. Each of these parameters may be set by a user based upon user preference and system operational parameters to achieve the most desirable number of perfectly exposed data frames without interfering in the ability of a police officer to complete their duties during a traffic stop 100.

As an example, if an administrator sets the frame capture rate 210 at thirty frames per second, and the headlamp power-up to power-down cycle 200 at 7 Hertz, with the power-down level at no less than 10% of full power, three to four frames in each headlamp cycle would be in the envelope of adequate exposure. The “adequate exposure” envelope is the range between Z₁ 230 and Zₕ 220. Below Z₁, 230 the light level is too low to provide adequate illumination for the data capture and above Zₕ 220 the light level is high enough to cause overexposure of the data frame. Thus, in this example, the system parameters are set such that 40 to 53% of captured data frames are within the adequate exposure envelope and potentially useful for later analysis and evidence.

All data captured by the system during operation is sent to an external data repository. Said external data repository may be located within a security office and the data may be transmitted from the recording system wirelessly or through a wired connection.

The example provided in the preceeding paragraphs is only one of a number of scenarios that may be provided by this invention. The process provides for any number of settings for the frame rate 210, power cycle rate 200 for the headlamps, and level of power to define the adequate exposure envelope. The example above is simple illustrative of one group of settings for the software module and the invention is not limited to this one example, but encompasses all possible settings for these parameters.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A process for use with a digital video recorder system to reduce light clutter in captured image data, the process comprising:
a) initializing a software module within a digital image and data recording system with at least two timing values;
b) means for determining a threshold for lighting conditions;
c) initiating operation of said software module when the threshold level is met;
d) manipulating a light source in accordance with said timing values;
e) recording a data stream including video image data and storing said captured data to a storage device;
f) investigating a data recording timing threshold setting;
g) repeating steps e and f if said timing threshold is not met;
h) and terminating the process if said timing threshold is met.

2. A process in accordance with claim 1 for use with a digital video recorder system to reduce light clutter in captured image data, the process further comprising:
in which said threshold for lighting conditions in step b is set to indicate adverse lighting conditions.

3. A process in accordance with claim 1 for use with a digital video recorder system to reduce light clutter in captured image data, the process further comprising:
said at least two timing values in step a are set to a desired frame rate speed and a power-on to power-off to power-on cycle of a lighting source.

4. A process in accordance with claim 3 for use with a digital video recorder system to reduce light clutter in captured image data, the process further comprising:
said at least two timing values are deliberately set to be de-synchronous one with the other,
wherein said data recorded includes image data captured at a number of different lighting exposure levels.
